(19) United States
(12) Patent Application Publication
(10) Pub. No.: US 2026/0350409 A1
(43) Pub. Date: Nov. 5, 2026

(54) DATASET SELECTION USING MODEL MIXING

(71) Applicant: Fujitsu Limited, Kawasaki-shi (JP)

(72) Inventors: Kasper VINKEN, Santa Clara, CA (US); Zhixu TAO, Princeton, NJ (US); Avraham COOPER, New York City, NY (US); Haowei YEH, Tokyo (JP); Xavier BOIX, Santa Clara, CA (US)

(73) Assignee: Fujitsu Limited, Kawasaki-shi (JP)

(21) Appl. No.: 19/195,516

(22) Filed: Apr. 30, 2025

(51) Int. Cl. G06N 3/096

(52) U.S. Cl. CPC G06N 3/096

(57) ABSTRACT

According to an embodiment, a method to select datasets to finetune a model includes obtaining a pretrained model and a plurality of candidate datasets for finetuning the pretrained model for a target task. A plurality of finetuned models corresponding to the plurality of candidate datasets are generated, each finetuned model corresponding to the pretrained model trained using a candidate dataset of the plurality of candidate datasets. A set of combined models are generated based on the plurality of finetuned models, individual combined models of the set of combined models representing different combinations of the plurality of finetuned models. One or more candidate datasets are selected from the plurality of candidate datasets based on performances of the individual combined models with respect to the target task and based on respective datasets corresponding to the individual combined models. The pretrained model is trained using the one or more candidate datasets as selected.

### FIELD

The embodiments discussed in the present disclosure are related to selecting one or more datasets for training a target model.

### BACKGROUND

Models such as machine learning (ML) models and deep learning models are configured to learn patterns, relationships, and insights from datasets. The models learn by identifying patterns in the data in the datasets. As such, the quality, size, and/or diversity of the datasets affect the performances of the models. For example, the datasets affect how accurate the models are, how the models handle rare cases, how consistent the models are with respect to different input types, among others. Datasets may also introduce biases to the models. For example, the datasets may introduce skewed demographics, cultural or linguistic biases, labeling biases, etc.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method to select datasets to finetune a pretrained model includes obtaining a pretrained model and a plurality of candidate datasets for finetuning the pretrained model for a target task. The method may further include generating a plurality of finetuned models corresponding to the plurality of candidate datasets, each individual finetuned model of the plurality of finetuned models corresponding to the pretrained model trained using an individual candidate dataset of the plurality of candidate datasets. A set of combined models are generated based on the plurality of finetuned models, individual combined models of the set of combined models representing different combinations of the plurality of finetuned models. One or more candidate datasets are selected from the plurality of candidate datasets based on performances of the individual combined models of the set of combined models with respect to the target task and based on respective datasets corresponding to the individual combined models. In some embodiments, the pretrained model is trained using the one or more candidate datasets as selected.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIGS. 1A-1B illustrate an example system configured to implement a dataset selection process for model finetuning, in accordance with at least one embodiment of the present disclosure;

FIG. 2 illustrates a flow chart of an example method of dataset selection and finetuning a pretrained model using model mixing, arranged in accordance with at least one embodiment of the present disclosure; and

FIG. 3 illustrates a block diagram of an example computing system that may be used with a dataset selection system, in accordance with one or more embodiments of the present disclosure.

### DETAILED DESCRIPTION

Learning models, such as machine learning models and deep learning models, learn patterns, relationships, and decision-making rules from datasets through a training process. The datasets act as the foundation for what the model knows-the better the data, the smarter and more accurate the model becomes. A model's ability to generalize new, unseen data heavily depends on how representative, clean, and well-labeled the training dataset is. As such finding the right dataset or a combination of datasets may have a direct impact on the performance of the models. Particularly, the datasets need to be large enough, diverse enough, and tailored to specific tasks that the models are designed to perform. A poor dataset may cause the models to be biased, inaccurate, or unsafe.

In some instances, a pretrained model may be finetuned or adapted to a target task. For instance, rather than training a model from scratch, a model that has been trained on general features corresponding to a target task may be finetuned using particular datasets specifically associated with the target task. Such a process may improve efficiency in training the models as the models are pretrained to certain extents.

In some instances, a set of candidate datasets may be available for finetuning the pretrained models. For example, different datasets may be available via different entities, repositories, and/or platforms. For instance, datasets may be available from governments, universities, tech companies, research communities, dataset deposits, etc. Using such existing datasets may provide certain benefits compared to curating new datasets. For example, use of existing datasets may help save time and resources, curated and preprocessed via prior uses, validated, etc. Certain datasets may be specific to the particular project. However, identifying and/or selecting specific datasets that are suitable for the project and/or the pretrained models may be challenging due to the vast number of available datasets. Additionally, different datasets may provide different results when combined.

Different approaches and/or methods may be used in identifying the combination of datasets from a set of candidate datasets for finetuning a pretrained model. For example, an existing approach includes a trial-and-error approach. A human operator selects which datasets to combine. Each dataset and combinations of datasets are used to finetune a model, and the finetuned model is tested to determine the suitability and/or effectiveness of the datasets and/or the combinations of the datasets for the target task. However, training models with combined datasets is expensive with respect to time and resources. Additionally, as the number of datasets in the set of candidate datasets increases, the possible combinations of the datasets increase substantially, which further increases the cost.

Another approach in selecting the datasets includes using all available datasets to finetune the pretrained model. For example, a model may be trained and/or finetuned using all candidate datasets instead of identifying the most suitable datasets and/or combinations of datasets. However, with respect to training models, more data does not necessarily translate to better accuracy. For instance, information that is unnecessary or irrelevant for a particular task for which the model is being trained may cloud the decision-making rules of the model and/or create an unnecessary bias toward a certain outcome. Additionally, such an approach may cause overfitting and/or data leakage (e.g., labels accidentally included in features) which may cause the model to perform well in training but fail in the real world.

Yet another existing approach includes selection based on dataset similarities. Similarities between the candidate datasets and a target or testing dataset be calculated, using metrics such as distribution overlap, or feature space proximity. Datasets with higher similarities may be selected based on the assumption that datasets similar to the target task will yield better finetuning results. However, such an approach is limited as the similarity metrics do not capture the complex, nonlinear relationships between the datasets and model performances. The approach struggles with selecting complementary datasets, in which combining dissimilar datasets may improve results due to diverse information.

According to one or more embodiments of the present disclosure, a method for identifying and/or selecting a combination of datasets for finetuning a pretrained model may include identifying the datasets based on a set of pretrained models, each pretrained model finetuned using a dataset from the set of candidate datasets. Particularly the individually trained pretrained models may be combined using model-mixing and tested such that the combinations of datasets may be tested based on the performances of corresponding finetuned models. In the present disclosure, a finetuned model corresponding to a particular dataset may refer to a pretrained model that is finetuned using the particular dataset.

In these and other embodiments, the testing and selection of the combination of datasets used to further finetune and train the model to generate the finetuned model may improve the technical field of AI models in several ways. For example, the systematic testing of dataset combinations may lead to more efficient resource allocation by identifying better and/or optimal dataset combinations without the need to train models on all possible combinations. This approach may reduce computational costs and time requirements that may otherwise be expended in traditional trial-and-error methods.

In terms of specific examples, a sentiment analysis model pretrained on general text corpora may be finetuned using various combinations of domain-specific datasets. A combination of social media posts, product reviews, and news articles may be found to produce a model that accurately captures sentiment across diverse contexts, outperforming models finetuned on any single dataset type.

For computer vision tasks, combining datasets with different annotation styles, lighting conditions, and object perspectives may lead to models with improved generalization capabilities. For instance, a model for detecting manufacturing defects may benefit from a combination of datasets containing images captured under different lighting conditions and camera angles, enabling more robust defect detection in real-world factory environments.

In natural language understanding applications, combining datasets from different languages or dialects may enhance multilingual capabilities. For example, a model finetuned on a combination of English, Spanish, and code-switched text may better serve diverse user populations than one trained on monolingual data alone.

The testing approach may also reveal non-intuitive dataset synergies. For example, in recommendation systems, combining a dataset of explicit user ratings with a dataset of implicit behavioral signals may create a model that better captures user preferences than one trained on either type of data alone, despite these datasets containing fundamentally different types of information.

Through these examples and methodologies, the testing and selection of dataset combinations may significantly advance the technical field of AI model development, leading to more effective, efficient, and equitable systems across a wide range of applications and domains.

Embodiments of the present disclosure will be explained with reference to the accompanying drawings.

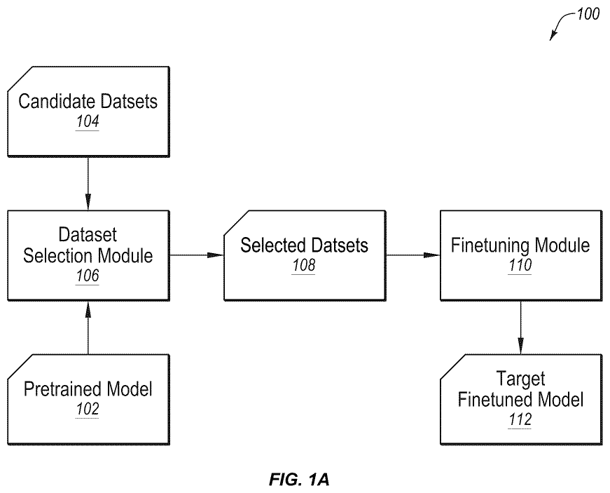

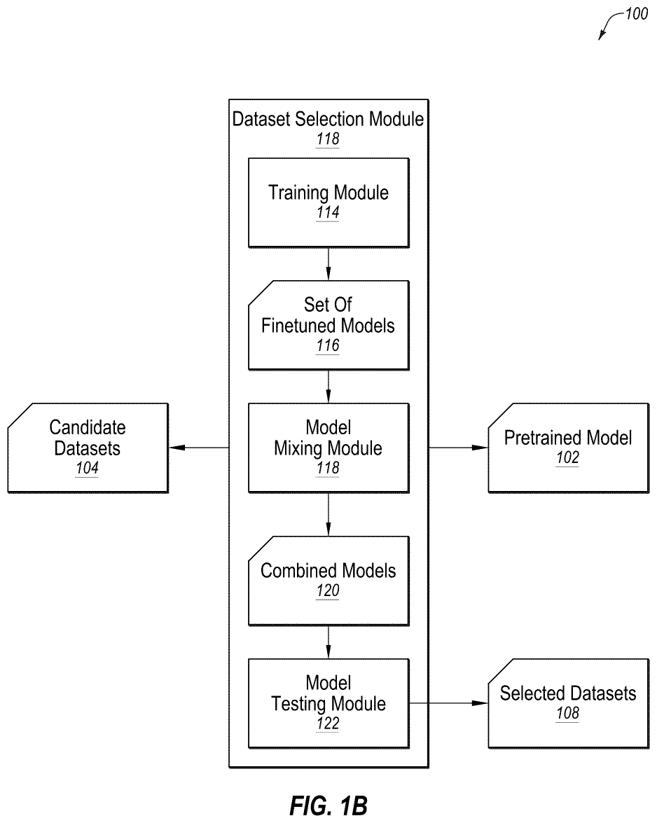

FIG. 1A illustrates an example system 100 configured to implement dataset selection based on model-mixing, in accordance with one or more embodiments of the present disclosure. In some embodiments, the system 100 may include a dataset selection module 106 and a finetuning module 110. In general, the system 100 may be configured to identify or select datasets (e.g., selected datasets 108) from a set of candidate datasets 104 that are suitable for finetuning a pretrained model 102 for a target task. The selected datasets 108 may be used to train and/or finetune the pretrained model 102 such that the pretrained model 102 becomes more suitable for performing a target task. In the present application, a target task may refer to a specific task or an objective that the pretrained model 102 is being finetuned to perform. The target task may be the downstream task that the pretrained model 102 is being adapted to, using the selected datasets 108. In some embodiments, the target task may refer to any functional aspect of the model that may be evaluated.

The pretrained model 102 may be an artificial intelligence (AI) model such as a machine learning or deep learning model that has already been trained on one or more datasets and learned general patterns, features, or representations. Different types of pretrained models may have different focuses and/or specialties. For example, the pretrained models may be prepared or pretrained with a focus on different tasks such as image classification, text classification, natural language processing, computer vision, audio and speech processing, multimodal processing, etc. In some embodiments, pretrained models, such as the pretrained model 102 may be finetuned such that the pretrained models perform well on a specific task. For example, one or more layers of the pretrained model 102 may be adjusted and/or replaced such that the pretrained model 102 is more suitable for the specific task. The pretrained model 102 may be further trained using one or more datasets associated with the target task.

In some embodiments, the pretrained model 102 may be selected such that the pretrained model 102 is generally associated with the target task. For example, in instances the target task is related to computer vision, the pretrained model 102 that has been pretrained with respect to the computer vision tasks and/or datasets may be selected to be finetuned.

In some embodiments, the pretrained model 102 may be finetuned based on one or more datasets from a set of candidate datasets 104. The candidate datasets 104 may include different datasets that may be relevant or helpful for the pretrained model 102 with respect to the target task. For example, the target task may be or include text classification, summarization, information retrieval, and/or opinion mining. In such instance, the candidate datasets 104 may include different datasets from different sources that may be associated with such tasks. For example, the candidate datasets 104 may include a first dataset including data from news, a second dataset including data from Wikipedia, and a third dataset including data from Tweets. In some embodiments, the candidate datasets 104 may include any number of suitable datasets.

In some embodiments, the dataset selection module 106 may be configured to identify and/or determine one or more datasets from the selected candidate datasets 104. For example, the dataset selection module 106 may identify and define selected datasets 108 from the candidate datasets 104 that are suitable for the target task. In general, the dataset selection module 106 may be configured to test different candidate datasets 104 and the combinations of the candidate datasets 104 using models that are each finetuned using an individual candidate dataset from the candidate datasets 104.

In some embodiments, the dataset selection module 106 may include code and routines configured to allow a computing system to perform one or more operations corresponding to the dataset selection module 106. Additionally or alternatively, the dataset selection module 106 may be implemented using hardware including one or more processors, a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Further, a reference to operations that are performed by the dataset selection module 106 may include operations that the dataset selection module 106 may cause some other component to perform.

With reference to FIG. 1B, in some embodiments, the dataset selection module 106 may include a training module 114, a model mixing module 118, and a model testing module 122. In some embodiments, the training module 114 may be configured to generate a set of finetuned models 116 (“finetuned models 116”) based on the pretrained model 102 and the candidate datasets 104. Each individual finetuned model of the set of finetuned models 116 may represent a version of the pretrained model 102 finetuned or trained using an individual candidate dataset of the candidate datasets 104. In these and other embodiments, a number of the finetuned models 116 may correspond to a number of the individual candidate datasets included in the candidate datasets 104.

For example, in an instance the candidate datasets 104 include three candidate datasets (e.g., a first candidate dataset, a second candidate dataset, and a third candidate dataset), the training module 114 may generate three finetuned models 116 including a first finetuned model, a second finetuned model, and a third finetuned model. In such instances, the first finetuned model may be the pretrained model 102 finetuned using the first candidate dataset, the second finetuned model may be the pretrained model 102 finetuned using the second candidate dataset, and the third finetuned model may be the pretrained model 102 finetuned using the third candidate dataset. While described with respect to three individual candidate datasets 104, the candidate datasets 104 may include any number of individual candidate datasets, in which instance, the training module 114 may generate a number of instances of the pretrained model 102 corresponding to the number of individual candidate datasets. In the present disclosure a reference to a finetuned model may include a reference to a candidate dataset that was used to finetune the finetuned model. For instance, the performance of a particular finetuned model may represent the performance of the candidate dataset used to finetune the particular finetune model.

In some embodiments, the model mixing module 118 may be configured to generate a set of combined models 120 based on the set of finetuned models 116. For example, the model mixing module 118 may perform model mixing with two or more individual finetuned models of the set of finetuned models 116 to generate the set of combined models 120. In the present disclosure, model mixing may refer to different techniques and/or processes of combining two or more AI models—or components of the models. The model mixing techniques may include taking average of the parameters or weights of the pretrained models, blending model outputs (e.g., ensemble methods), merging internal representations (e.g., feature-level fusion), interpolating model parameters, and/or integrating models trained on different data domains or modalities. For example, model mixing the first finetuned model and the second finetuned model may include combining the first finetuned model and the second finetuned model such that the combined model exhibits behaviors, knowledge, or styles from both the first finetuned model and the second finetuned model.

In these and other embodiments, the combined models 120 may be similar in scope and functions to the pretrained model 102 finetuned using combined datasets. For example, a combined model generated from combining the first finetuned model and the second finetuned model may be similar in scope and functions to the pretrained model 102 finetuned using a combined dataset of the first candidate dataset and the second candidate dataset. In these and other embodiments, the combined models 120 may improve efficiency over finetuning the pretrained model 102 using the combined datasets.

For instance, combining the finetuned models 116 provides computational efficiency over combining the datasets first and finetuning the pretrained model 102 with the combined datasets.. For example, combining the finetuned models 116 may be efficient as the need for additional fine-tuning, which is computationally expensive, is eliminated. For instance, combining multiple datasets first and training or finetuning the pretrained model 102 with combined datasets increases the total number of samples and increases the training time compared to finetuning the pretrained model using individual candidate datasets. Further, combined datasets may include different distributions (e.g., different writing types, domains, etc.) from multiple candidate datasets, in which instance, the pretrained model 102 is required to learn to generalize across the different distributions. Such a process may lead to slower convergence, as the pretrained model 102 is constantly adjusting weights to accommodate multiple patterns or distributions. Larger datasets (e.g., combined datasets) also require higher memory usage and longer backpropagation steps.

Contrastingly, separately finetuning the multiple models using individual candidate datasets 104 may improve efficiency. For instance, the finetuned models 116 may be trained in parallel or at the same time using separate machines or processors. Even in instances in which the models are trained sequentially, the models may be finetuned faster as the models are finetuned using smaller datasets compared to combining multiple datasets first and finetuning the models using the combined datasets. Additionally, the individual finetuning may permit each model to specialize quickly to different domains without having to consider conflicting patterns or distributions between the datasets. With the individual models trained and/or finetuned, mixing the models is generally a faster step or process than the training process. For example, model mixing may skip certain time-consuming parts of training, such as forward passes, loss computation, and gradient descent. Such time-consuming parts are replaced with simple mathematical operations (e.g., averaging) on the weights of the finetuned models 116. Additionally, with model mixing, epochs and/or iterations, which are generally required with training with combined datasets, are not needed.

Further, the model mixing techniques may approximate well the trends of fine-tuning on combinations of datasets. For instance, a high correlation exists between the accuracy of the mixture combinations and the accuracy of fine-tuning on the combination. Particularly, the combined models 120 may represent the combined datasets sufficiently for dataset comparisons and selections. Accordingly, combining the finetuned models is more efficient than combining the datasets and finetuning the pretrained model 102 with the combined datasets along with maintaining similar accuracy.

In some embodiments, the combined models 120 generated by the model mixing module 118 may include combined models 120 representing all possible combinations or variations among the candidate datasets 104. For example, with the candidate datasets 104 including the first candidate dataset, the second candidate dataset, and the third candidate dataset, the possible combinations or variations of the combined models 120 may include a first combined dataset based on finetuned models finetuned using the first candidate dataset and the second candidate dataset, a second combined dataset based on finetuned models finetuned using the first candidate dataset and the third candidate dataset, a third combined dataset based on finetuned models finetuned using the second candidate dataset and the third candidate dataset, and a fourth combined dataset based on finetuned models finetuned using the first candidate dataset, the second candidate dataset, and the third candidate dataset. The combined models 120 may include models that are not specifically combined, such that models that are only trained using one dataset from the candidate datasets 104 may be tested.

In some embodiments, the mixing module 118 may place different weights to the finetuned models 116 in generating the combined models 120. The weights may represent different levels of influence given to the finetuned models 116 in generating the combined models 120. For instance, a combined model including a first finetuned model finetuned using the first dataset, a second finetuned model finetuned using the second dataset, and a third finetuned model finetuned using the third dataset may assign various weights to the first finetune model, the second finetuned model, and the third finetune model in generating the combined model. In some embodiments, certain finetuned models 116 may perform better (e.g., better accuracy), be more robust to noise, and/or generalized better. Assigning different weights to the finetune models 116 may help improve performances of the combined models 120.

In some embodiments, the combined models 120 may include multiple combined models generated from the same set of finetuned models. For example, the combined models 120 may include multiple models generated from the same set of finetune models (e.g., the first finetuned model, the second finetuned model, and the third finetuned model). In some embodiments, particular set of weights may be determined for the particular combined model based on a search strategy or algorithm. For example, search algorithms such as a gird search, a random search, Bayesian optimization, genetic algorithms, an evolutionary search, constrained optimization algorithms, etc. may be used to determine the set of weights.

In some embodiments, as the number of candidate datasets 104 increases, the number of possible combinations across the candidate datasets 104 may increase substantially. In such instances, testing all combinations of the candidate datasets 104 may become computationally burdensome, or impossible in some instances as the numbers increase. In some embodiments, one or more search algorithms may be used to test a subset of possible combinations, rather than testing all combinations. For instance, a certain combination of the candidate datasets 104 may be tested using corresponding combined models 120. In these and other embodiments, different types of search algorithms may be used to define the subset of the candidate datasets 104. For example, the search algorithms may include greedy search, random search, genetic algorithms, Bayesian optimization, beam search, simulated annealing, among others. In these and other embodiments, the search algorithms may help identify a set of combinations that may generally provide performance evaluations for each candidate dataset 104.

In some embodiments, the model testing module 122 may be configured to test the combined models 120. For example, the model testing module 122 may test performances of the combined models 120 with respect to a test dataset. In some embodiments, the test dataset may be a separate dataset associated with the target task. For instance, with the target task being image classification, the test dataset may include various image classification results. In some embodiments, the test dataset may be obtained from a user or an entity associated with the target task. In some embodiments, the test dataset may be a part of the candidate datasets 104. For example, one of the candidate datasets 104 may be removed from the finetuning (e.g., by the training module 114) and the model mixing (e.g., by the model mixing module 118) such that the dataset may be used to test the combined models 120.

In these and other embodiments, the performances of the combined models 120 may represent the performances or suitability of the corresponding candidate datasets 104 and/or combinations of candidate datasets 104. For example, a performance of a combined model generated based on a combination of a model finetuned using a first candidate dataset and a model finetuned using a second candidate dataset may represent a suitability of finetuning the pretrained model 102 with the first candidate dataset and the second candidate dataset for the specific task. In these and other embodiments, the model testing module 122 may be configured to identify the best-performing combined model, and consequently, a best-performing combination of candidate datasets 104 based on the performance tests of the combined models 120. In some embodiments, the model testing module 122 may provide such candidate datasets as the selected datasets 108. The number of individual candidate datasets included in the selected datasets 108 may vary based on the target task the pretrained model 102 is being finetuned for and the types of datasets that are included in the candidate datasets 104. In some instances, the selected datasets 108 may include small numbers as low as just a single candidate dataset. In other instances, the selected datasets 108 may include large numbers up to all of the candidate datasets 104.

Returning to FIG. 1A, in some embodiments, the finetuning module 110 may train the pretrained model 102 using the selected datasets 108 to generate a target finetuned model 112. In these and other embodiments, the target finetuned model 112 may be prepared to perform the target task. In some embodiments, the target finetuned model 112 may be selected from the set of combined models 120 of FIG. 1B, rather than finetuning the pretrained model 102 using the selected datasets 108. For instance, the best-performing model from the set of combined models 120 may be selected and provided as the target finetuned model 112, as the best-performing model is already finetuned using the combination of candidate datasets 104 corresponding to the selected datasets 108.

In other embodiments, the target finetuned model 112 may be separately finetuned. For example, the pretrained model 102 may be finetuned using a combined dataset including the selected datasets 108. In these and other embodiments, the target finetuned model 112 that is finetuned using the combined dataset may provide better accuracy and/or performance compared to the combined models 120 as the target finetuned model 112 learns joint patterns and relationships across the selected datasets 108. Identifying the selected datasets 108 based on the combined models 120 and finetuning the target finetuned model 120 using the selected datasets may generate the target finetuned model 112 with increased efficiency compared to attempting to determine the selected datasets 108 based on combined datasets from the beginning.

In some embodiments, the finetuning module 110 may generate the target finetuned model 112 based on the selected datasets 108 and respective weights of the selected datasets 108. For example, the selected datasets 108 may be selected from the combined models 120 that represent combination of finetuned models 116, in which the finetuned models are given different weights or emphasis in the combination. In these and other embodiments, the selected datasets 108 may have corresponding weights or influence. In these and other embodiments, the finetuning module 110 may generate the finetuned model 112 based on the weights.

For example, in generating a particular combined model, a first finetune model may be given twice as much as the weight of a second finetuned model. In response to identifying the particular combined model as the best-performing model, a first candidate dataset (e.g., the candidate dataset used to finetune the first finetuned model) and a second candidate dataset (e.g., the candidate dataset used to finetune the second finetuned model) may be determined as the selected datasets 108. In these and other embodiments, the finetuning module 110 may be configured to finetune the pretrained model 102 using the first candidate dataset and the second candidate dataset to generate the target finetuned model 112. In some embodiments, the first candidate dataset and the second candidate dataset may be given different weights in generating the target finetuned model 112. For example, the first candidate dataset may be given twice as much weight as the second candidate dataset, representing the weights of respective individual finetuned models (e.g., the first finetuned model and the second finetuned model, respectively). In some embodiments, the selected datasets 108 may be given different weights based on sampling. For example, the first candidate dataset may be upsampled and the second candidate dataset may be sampled less.

Modifications, additions, or omissions may be made to the system 100 without departing from the scope of the present disclosure. For example, in some embodiments, the system 100 may include any number of other components that may not be explicitly illustrated or described.

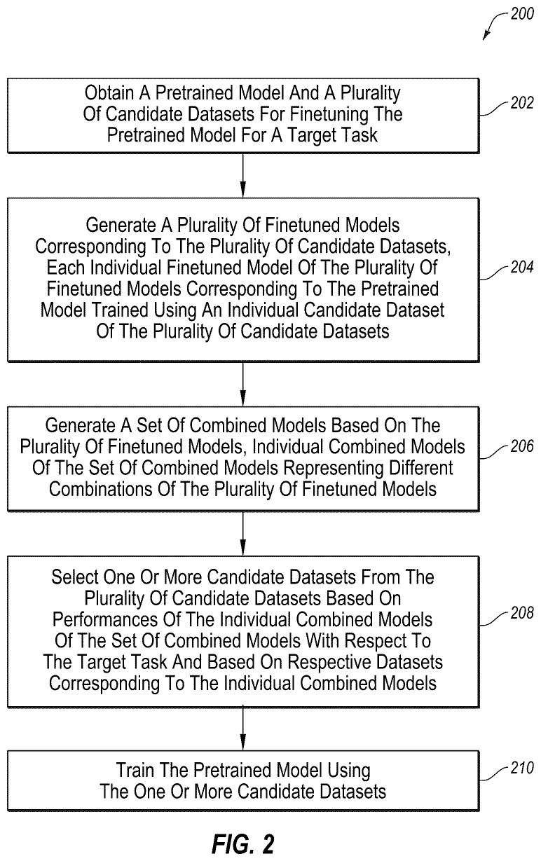

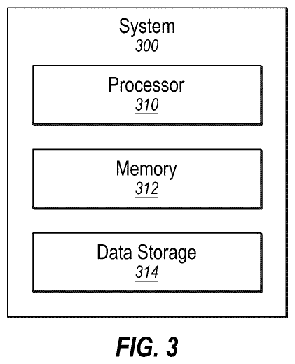

FIG. 2 illustrates a flow diagram of an example method 200 of finetuning a model based on selected datasets, in accordance with one or more embodiments of the present disclosure. The method 200 may be performed by any suitable system, apparatus, or device. For example, the method 200 may be implemented using the system 100 of FIGS. 1A-1B or the computing system 300 of FIG. 3. Although illustrated with discrete blocks, the steps and operations associated with one or more blocks of the method 200 may be divided into additional blocks, combined into fewer blocks, or eliminated, depending on the particular implementation.

In some embodiments, the method 200 may begin at block 202. At block 202, a pretrained model and a set of candidate datasets may be obtained. In some embodiments, the set of candidate datasets may include datasets that may be used in finetuning the pretrained model for a target task. The target task may vary based on different projects the pretrained model is being trained for. In some embodiments, the pretrained model may be selected and/or defined such that the predefined model is suitable for the target task. In some embodiments, the pretrained model may correspond to the pretrained model 102 of FIGS. 1A-1B, and the candidate datasets may correspond to the candidate datasets 104 of FIGS. 1A-1B. In some embodiments, the candidate datasets may be obtained from dataset repositories. Additionally or alternatively, the candidate datasets may be obtained from an entity associated with the target task.

In some embodiments, individual finetuned models combined to generate each individual combined model may be assigned respective weights. The respective weights may represent the relative influence of each individual finetuned model on the each individual combined model. For example, different individual finetuned models may have different levels of influence on forming the individual finetuned models. In some embodiments, the weights may be assigned to improve or increase the efficiency of the combined models. In some embodiments, the weights placed on the individual finetuned models may represent the weights placed on the candidate datasets used to finetune the individual finetuned models.

At block, 204, a set of finetuned models corresponding to the set of candidate datasets may be generated. In some embodiments, each individual finetuned model of the set of finetune models may correspond to the pretrained model trained using an individual candidate dataset of the set of candidate datasets. For example, different copies or instances of the pretrained model each be trained using a particular candidate dataset, such that each candidate dataset is represented using a corresponding finetuned model. In some embodiments, the set of finetuned models may correspond to the set of finetuned models 116 of FIG. 1B.

At block 206, a set of combined models may be generated based on the set of finetuned models. In some embodiments, individual combined models of the set of combined models may represent different combinations of the set of finetuned models. In some embodiments, the set of combined models may be generated using any suitable model mixing techniques or processes. For example, in some embodiments, generating the set of combined models may include taking an average of weights or parameters of two or more finetuned models. In these and other embodiments, combining the finetuned models may be faster and/or more efficient than combining the candidate datasets first and finetuning the pretrained model using the combined candidate datasets.

In some embodiments, the set of combined models may include all possible combinations across the set of finetuned models. In other embodiments, the set of combined models may include a subset of combinations of all possible combinations across the set of finetuned models. In some embodiments, the subset of combinations may be determined using a search algorithm, such as greedy search, random search, genetic algorithms, Bayesian optimization, beam search, simulated annealing, etc. In some embodiments, the set of combined models may include individual finetuned models that are not combined with other finetuned models. Such individual finetuned models may be used to test performances of individual candidate datasets. In some embodiments, the set of combined models may correspond to the combined models 120 of FIG. 1B.

At block 208, one or more candidate datasets from the plurality of candidate datasets may be selected based on performances of the individual combined models of the set of combined models with respect to the target task and based on respective datasets corresponding to the individual combined models. In these and other embodiments, the respective datasets may refer to one or more candidate datasets that were used to finetune one or more finetuned models combined to generate the individual combined models. In these and other embodiments, the performances of the individual combined models of the set of combined models respect to the target task may represent suitability of the respective datasets used to finetune the plurality of finetuned models included in the individual combined models.

In some embodiments, selecting the one or more candidate datasets may include testing the individual combined models of the set of combined models with respect to a test dataset. For example, the individual combined models may be tested for accuracy with respect to the test dataset. In some embodiments, the test dataset may be associated with the target task. The best-performing combined model may be identified and/or determined based on the testing. In these and other embodiments, the one or more candidate datasets included in the best-performing combined model may be selected. In some embodiments, the one or more candidate datasets being included in a combined model may refer to the combined model including finetuned models finetuned using the one or more candidate datasets.

At block 210, the pretrained model may be trained and/or finetuned using the one or more candidate datasets selected from the set of candidate datasets. In these and other embodiments, the finetuned pretrained model may be more suitable for the target task. In some embodiments, the one or mor candidate datasets may be assigned respective weights in finetuning the pretrained model. The respective weights may be assigned based on the weights placed on the individual finetuned models in generating the best-performing combined model.

Modifications, additions, or omissions may be made to the method 200 without departing from the scope of the present disclosure. For example, the outlined steps and operations are only provided as examples, and some of the steps and operations may be optional, combined into fewer steps and operations, or expanded into additional steps and operations without detracting from the essence of the disclosed embodiments.

For example, while described with respect to finetuning a pretrained model, the candidate datasets may be used to train a model from scratch. For example, the dataset selection process described with respect to FIGS. 1A-2 may be used to identify a combination of datasets that are suitable for training a model from scratch for a target task.

FIG. 3 illustrates a block diagram of an example computing system 300 that may be used with respect to dataset selection system, according to at least one embodiment of the present disclosure. For example, the computing system 300 may be used to implement dataset selection and model finetuning framework discussed with respect to FIGS. 1A-2.

The computing system 300 may include a processor 310, a memory 312, a data storage 314, and a user interface 316. The processor 310, the memory 312, the data storage 314, and the user interface may be communicatively coupled.

In general, the processor 310 may include any suitable special-purpose or general-purpose computer, computing entity, or processing device including various computer hardware or software modules and may be configured to execute instructions stored on any applicable computer-readable storage media. For example, the processor 310 may include a microprocessor, a central processing unit (CPU), a graphics processing unit (GPU), a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 4, the processor 310 may include any number of processors configured to, individually or collectively, perform or direct performance of any number of operations described in the present disclosure. Additionally, one or more of the processors may be present on one or more different electronic devices, such as different servers.

In some embodiments, the processor 310 may be configured to interpret and/or execute program instructions and/or process data stored in the memory 312, the data storage 314, or the memory 312 and the data storage 314. In some embodiments, the processor 310 may fetch program instructions from the data storage 314 and load the program instructions in the memory 312. After the program instructions are loaded into memory 312, the processor 310 may execute the program instructions.

The memory 312 and the data storage 314 may include computer-readable storage media for carrying or having computer-executable instructions or data structures stored thereon. Such computer-readable storage media may include any available media that may be accessed by a general-purpose or special-purpose computer, such as the processor 310. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 310 to perform a certain operation or group of operations.

The user interface 316 may include any device to allow a user to interface with the computing system 300. For example, the user interface 316 may include a mouse, a track pad, a keyboard, buttons, camera, and/or a touchscreen, among other devices. The user interface 316 may receive input from a user and provide the input to the processor 310.

Modifications, additions, or omissions may be made to the computing system 300 without departing from the scope of the present disclosure. For example, in some embodiments, the computing system 300may include any number of other components that may not be explicitly illustrated or described.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Additionally, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B” even if the term “and/or” is used elsewhere.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method comprising:
obtaining a pretrained model and a plurality of candidate datasets for finetuning the pretrained model for a target task;
generating a plurality of finetuned models corresponding to the plurality of candidate datasets, each individual finetuned model of the plurality of finetuned models corresponding to the pretrained model trained using an individual candidate dataset of the plurality of candidate datasets;
generating a set of combined models based on the plurality of finetuned models, individual combined models of the set of combined models representing different combinations of the plurality of finetuned models;
selecting one or more candidate datasets from the plurality of candidate datasets based on performances of the individual combined models of the set of combined models with respect to the target task and based on respective datasets corresponding to the individual combined models; and
training the pretrained model using the one or more candidate datasets as selected.

2. The method of claim 1, wherein the performances of the individual combined models of the set of combined models with respect to the target task represent suitability of the respective datasets used to finetune the plurality of finetuned models included in the individual combined models.

3. The method of claim 1, wherein selecting one or more candidate datasets from the plurality of candidate datasets based on the set of combined models comprises:
testing the individual combined models of the set of combined models with respect to a test dataset;
identifying a best-performing combined model based on the testing; and
identifying the one or more candidate datasets included in the best-performing combined model.

4. The method of claim 3, wherein the test dataset is associated with the target task.

5. The method of claim 1, wherein the set of combined models includes all possible combinations across the plurality of finetuned models.

6. The method of claim 1, wherein the set of combined models includes a subset of combinations of all possible combinations across the plurality of finetuned models, the subset determined using a search algorithm.

7. The method of claim 1, wherein the set of combined models includes at least one combined model combining two or more finetune models.

8. The method of claim 1, wherein the pretrained model is selected based on the target task.

9. The method of claim 1, wherein generating the set of combined models based on the plurality of finetuned models comprises taking an average of weights of two or more finetuned models.

10. The method of claim 1, wherein the set of combined models includes individual finetuned models.

11. The method of claim 1, wherein a number of individual finetuned models of the plurality of finetuned models is equivalent to a number of individual candidate datasets in the plurality of candidate datasets.

12. The method of claim 1, wherein individual finetuned models combined to generate each individual combined model are assigned respective weights, the respective weights representing relative influence of each individual finetuned model on the each individual combined model.

13. One or more non-transitory computer-readable media storing instructions that, when executed by one or more processors, cause a system to perform operations, the operations comprising:
obtaining a pretrained model and a plurality of candidate datasets for finetuning the pretrained model for a target task;
generating a plurality of finetuned models corresponding to the plurality of candidate datasets, each individual finetuned model of the plurality of finetuned models corresponding to the pretrained model trained using an individual candidate dataset of the plurality of candidate datasets;
generating a set of combined models based on the plurality of finetuned models, individual combined models of the set of combined models representing different combinations of the plurality of finetuned models;
selecting one or more candidate datasets from the plurality of candidate datasets based on performances of the individual combined models of the set of combined models with respect to the target task and based on respective datasets corresponding to the individual combined models; and
selecting a combined model to perform the target task, from the set of combined models, the combined model representing a combination of the plurality of finetuned models corresponding to the one or more candidate datasets as selected.

14. The one or more non-transitory computer-readable media of claim 13, wherein the performances of the individual combined models of the set of combined models with respect to the target task represent suitability of the respective datasets used to finetune the plurality of finetuned models included in the individual combined models.

15. The one or more non-transitory computer-readable media of claim 13, wherein selecting one or more candidate datasets from the plurality of candidate datasets based on the set of combined models comprises:
testing the individual combined models of the set of combined models with respect to a test dataset;
identifying a best-performing combined model based on the testing; and
identifying the one or more candidate datasets included in the best-performing combined model.

16. The one or more non-transitory computer-readable media of claim 15, wherein the test dataset is associated with the target task.

17. The one or more non-transitory computer-readable media of claim 13, wherein the set of combined models includes all possible combinations across the plurality of finetuned models.

18. The one or more non-transitory computer-readable media of claim 13, wherein the set of combined models includes a subset of combinations of all possible combinations across the plurality of finetuned models, the subset determined using a search algorithm.

19. The one or more non-transitory computer-readable media of claim 13, wherein the set of combined models includes at least one combined model combining two or more finetune models.

20. The one or more non-transitory computer-readable media of claim 13, wherein the pretrained model is selected based on the target task.
